(19) United States
(12) Patent Application Publication
(10) Pub. No.: US 2002/0131523 A1
(43) Pub. Date: Sep. 19, 2002

(54) Circuit and method for compensating for non-linear distortion

(75) Inventors: Hiroyuki Nagasaka, Yokohama (JP); Shinichi Haruyama, Yokohama (JP)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/100,620

(22) Filed: Mar. 18, 2002

(30) Foreign Application Priority Data
Mar. 19, 2001 (JP) 2001-79532
Mar. 19, 2001 (JP) 2001-79533

(51) Int. Cl. H04K 1/02; H04L 25/03; H04L 25/49

(52) U.S. Cl. 375/297; 375/302

(57) ABSTRACT

Compensating for non-linear distortion generated during non-linear high-power amplification in a transmitter after quadrature modulation of a baseband signalby extracting a non-linear distortion component from a non-linearly high-power amplified modulated signal; correcting a phase characteristic such that respective frequency signals in a frequency band of the non-linear distortion component have equal phase delays; quadrature-demodulating the corrected distortion component into a baseband distortion component; and overlapping a phase-inverted distortion component of the quadrature-demodulated baseband distortion component with the baseband signal.

### PRIORITY

This application claims priority to an application entitled “Circuit and Method for Compensating for Non-linear Distortion” filed in the Japanese Patent Office on Mar. 19, 2001 and assigned Serial No. 2001-79532, and an application entitled “Circuit and Method for Compensating for Non-linear Distortion” filed in the Japanese Patent Office on Mar. 19, 2001 and assigned Serial No. 2001-79533, the contents of both of which are hereby incorporated by reference.

### BACKGROUND OF THE INVENTION

1. Field of the Invention

The present invention relates generally to a quadrature modulation circuit used in a radio transmitter, and in particular, to an apparatus and method for compensating for non-linear distortion generated during high-power amplification after quadrature modulation of a baseband signal.

2. Description of the Related Art

A conventional quadrature (or orthogonal) modulation circuit quadrature-modulates a baseband signal and then high-power amplifies the modulated signal. The high-power amplified modulated signal is subject to non-linear amplification in order to improve power efficiency. This is because an amplification region of an amplifier is divided into a linear region and a non-linear region, and the high-power amplification is performed in the non-linear region. When amplified in the non-linear region, the amplified modulated signal suffers non-linear distortion. Thus, in order to linearize an input/output characteristic, it is necessary to compensate for distortion of the nonlinearly distorted signal. A typical, conventional non-linear distortion compensation circuit includes a predistortion-type non-linear distortion compensation circuit shown in FIG. 8.

A predistortion-type non-linear distortion compensation circuit will be described with reference to FIG. 8. Referring to FIG. 8, complex baseband signals I and Q are applied to a first D/A (Digital-to-Analog) converter 2 and a second D/A converter 3 through a distortion compensation operator 1. The first and second D/A converters 2 and 3 convert received digital signals to analog signals, and provide the converted analog signals to a quadrature modulator 4. The quadrature modulator 4 quadrature-modulates received baseband signals I and Q, and provides the quadrature-modulated signals to a high-power amplifier (BPA) 5. The high-power amplifier 5 then high-power amplifies the quadrature-modulated analog signals.

A compensation data table 7 stores compensation data in the form of a table. The compensation data stored in the compensation data table 7 is determined by previously measuring a non-linear characteristic of the high-power amplifier 5 during amplification. A power calculator 6 calculates power of the baseband signals I and Q, and provides the calculated power information to the compensation data table 7. The compensation data table 7 reads compensation data corresponding to the calculated power by consulting the table according to the power of the baseband signals I and Q, and then provides the read compensation data to the distortion compensation operator 1.

In this way, the distortion compensation operator 1 applies an inverse distortion component for canceling the non-linear distortion generated in the high-power amplifier 5 to the received baseband signals I and Q before quadrature modulation. The signals including the inverse distortion component for removing the non-linear distortion are provided to the first and second D/A converters 2 and 3. As a result, the non-linear distortion of the modulated signals amplified by the high-power amplifier 5 may be reduced.

As stated above, the conventional predistortion-type non-linear distortion compensation circuit compensates for non-linear distortion through the use of the compensation data table based on the power of the baseband signals. This is done without considering a characteristic deviation of the high-power amplifier 5 and a variation of temperature. Overall performance of the circuit may be deteriorated due to the characteristic deviation of the high-power amplifier 5 and the temperature variation.

To solve this problem, a directional combiner 8, as illustrated in FIG. 9, divides an output of the high-power amplifier 5 into two signals, and applies one of the divided signals to a quadrature demodulator 9. The quadrature demodulator 9 quadrature-demodulates the divided signal and feeds the demodulated divided signal to a compensation data operator 10. The compensation data operator 10 multiplies a coefficient based on the feedback information by data read from an internal compensation data table (though not shown, it is equivalent to the compensation data table 7 of FIG. 8). The compensation data operator 10 provides the distortion compensation operator 1 with compensated data having a high accuracy regardless of the characteristic deviation of the high-power amplifier 5 and the temperature variation, since the compensated data is based on the output of high-power amplifier 5.

However, since the elements 8-10 of FIG. 9 generate pseudo non-linear distortion themselves, it is not possible to completely resolve the problem. In addition, all these elements perform a complicated digital operation, resulting in an increase in the circuit size and cost. Further, the increase in the circuit size increases power consumption, causing a reduction in a batter-run time of a mobile communication terminal that uses a battery as a power source.

To solve this problem, the applicant has proposed a non-linear distortion compensation circuit of FIG. 7, disclosed in Japanese patent application No. 2000-233631, the contents of which are hereby incorporated by reference. The non-linear distortion compensation circuit includes directional combiners/dividers 19 and 21, a delay circuit/phase shifter 20, an attenuator 13, a subtracter 14, a quadrature modulator 11, a quadrature demodulator 15, a phase adjuster 22, amplitude adjusters 23 and 24, and subtracters 16 and 17.

The non-linear distortion compensation circuit interposes the directional combiner/divider 19 between the quadrature modulator 11 and a high-power amplifier 12. The directional combiner/divider 19 divides a modulated signal provided from the 30 quadrature modulator 11 into two signals, and provides one of the divided modulated signals to the delay circuit/phase shifter 20, and provides a second one of the divided modulated signals to high-power amplifier 12. The delay circuit/phase shifter 20 then shifts a phase of the received signal to match it to a phase of an output signal of the attenuator 13, and then provides the phase-shifted signal to the subtracter 14. The subtracter 14 calculates a difference between the signal from the delay circuit/phase shifter 20 and the signal from the attenuator 13, and provides the difference to the phase adjuster 22. That is, a non-linear distortion component calculated by the subtracter 14 is phase-adjusted through the phase adjuster 22, and then provided to the quadrature demodulator 15. Baseband non-linear distortion components output from the quadrature demodulator 15 are amplitude-adjusted to a proper level through the amplitude adjusters 23 and 24, and then provided to the subtracters 16 and 17.

Disadvantageously, however, this conventional distortion compensation circuit must feed the signal output from the high-power amplifier 12 back to an input side of the quadrature modulator 11. The feedback route is formed through the directional combiners/dividers 19 and 21, the delay circuit/phase shifter 20, the attenuator 13 and the subtracter 14, the phase adjuster 22, the quadrature demodulator 15, the amplitude adjusters 23 and 24, and the subtracters 16 and 17.

In this feedback route, an electric length of the feedback route from the subtracter 14 to quadrature demodulator 15 may be lengthened. When the electric length of the feedback route increases, the distortion component fed back to the input side of the quadrature modulator 11 has different phase delays at different frequencies in a frequency band of the distortion component. That is, although the distortion component is transmitted through the same transmission line having a specific length, the distortion component has different phase delays. The phase delay is greater at higher frequencies than at lower frequencies.

However, the non-linear compensation circuit proposed by the applicant cannot compensate for distortion of a wideband modulation signal, if a phase delay is not adjusted at a point in time when the feedback distortion component is combined with the original transmission signal over the entire range of frequencies in the frequency band of the distortion component. To solve this problem, it is possible to increase a frequency band for effectively compensating for the distortion by shortening the feedback route. However, shortening the feedback route may not be easy in the light of limited circuit restructuring capabilities.

### SUMMARY OF THE INVENTION

Therefore, it is an object of the present invention to provide a non-linear distortion compensation apparatus and method for compensating for distortion of a wideband modulation signal.

To achieve the above and other objects, the present invention provides a method for compensating for non-linear distortion generated during non-linear high-power amplification in a transmitter after quadrature modulation of a baseband signal. The method comprises extracting a non-linear distortion component from a non-linearly high-power amplified modulated signal; correcting a phase characteristic such that respective frequency signals in a frequency band of the non-linear distortion component have equal phase delay; quadrature-demodulating the corrected distortion component into a baseband distortion component; and overlapping a phase-inversed distortion component of the quadrature-demodulated baseband distortion component with the baseband signal.

In accordance with one aspect of the present invention, there is provided an apparatus for compensating for non-linear distortion generated during non-linear high-power amplification in a transmitter after quadrature modulation of a baseband signal. The apparatus comprises a distortion extractor for extracting a non-linear distortion component from a non-linearly amplified quadrature-modulated signal; a phase characteristic corrector for correcting a phase characteristic such that respective frequency signals in a frequency band of the non-linear distortion component have equal phase delay; a quadrature demodulator for quadrature-demodulating the phase characteristic-corrected distortion component into a baseband distortion component; and a distortion overlapping section for overlapping a phase-inversed distortion component of the baseband distortion component output from the quadrature demodulator with the baseband signal.

Preferably, the phase characteristic corrector comprises a frequency band divider for dividing a frequency band of the distortion component extracted by the distortion extractor into a plurality of frequency bands; a plurality of delay circuits for performing phase adjustment such that the respective frequency bands of the distortion component divided by the frequency band divider have equal phase delay; and a signal combiner for combining outputs of the plurality of delay circuits.

Alternatively, the phase characteristic corrector comprises a filter, a pass band of which is equal to the frequency band of the distortion component extracted by the distortion extractor. Preferably, the system is designed such that the filter group delay decreases as the frequency increases.

In accordance with another aspect of the present invention, there is provided a method for compensating for non-linear distortion generated during non-linear high-power amplification in a transmitter after quadrature modulation of a baseband signal. The method comprises extracting a non-linear distortion component from a non-linearly high-power amplified quadrature-modulated signal; dividing a frequency band of the extracted non-linear distortion component into a plurality of frequency bands; quadrature-demodulating the frequency band-divided non-linear distortion components into baseband distortion components such that the quadrature-demodulated baseband distortion components have equal phase delays; combining the quadrature-demodulated baseband non-linear distortion components; and overlapping phase-inversed distortion component of the combined baseband distortion component with the baseband signal.

In accordance with further another aspect of the present invention, there is provided a circuit for compensating for non-linear distortion generated during non-linear high-power amplification in a transmitter after quadrature modulation of a baseband signal. The circuit comprises a distortion extractor for extracting a non-linear distortion component from a non-linearly high-power amplified quadrature-modulated signal; a frequency divider for dividing a frequency band of the extracted non-linear distortion component into a plurality of frequency bands; a plurality of quadrature demodulators for quadrature demodulating the frequency band-divided non-linear distortion components into baseband distortion components such that respective frequencies have equal phase delays; a combiner for combining the quadrature-demodulated baseband non-linear distortion components; and a distortion overlapping section for overlapping phase-inversed distortion component of the combined baseband distortion component with the baseband signal.

Further, the apparatus comprises a phase adjuster for independently adjusting a phase of a carrier signal input into the plurality of quadrature demodulators.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a structure of a non-linear distortion compensation circuit according to a first embodiment of the present invention;

FIG. 2 illustrates a detailed structure of a phase characteristic correction circuit in the non-linear distortion compensation circuit of FIG. 1;

FIG. 3 illustrates a frequency band of a feedback distortion component;

FIG. 4 illustrates a structure of a modified phase characteristic correction circuit according to an embodiment of the present invention;

FIG. 5 illustrates a group delay characteristic of a bandpass filter in the phase characteristic correction circuit of FIG. 4;

FIG. 6 illustrates a copper film pattern on a substrate where the bandpass filter in the phase characteristic correction circuit of FIG. 4 is implemented with a SAW (Surface Acoustic Wave) filter;

FIG. 7 illustrates a structure of a known non-linear distortion compensation circuit;

FIG. 8 illustrates a structure of a conventional non-linear distortion compensation circuit;

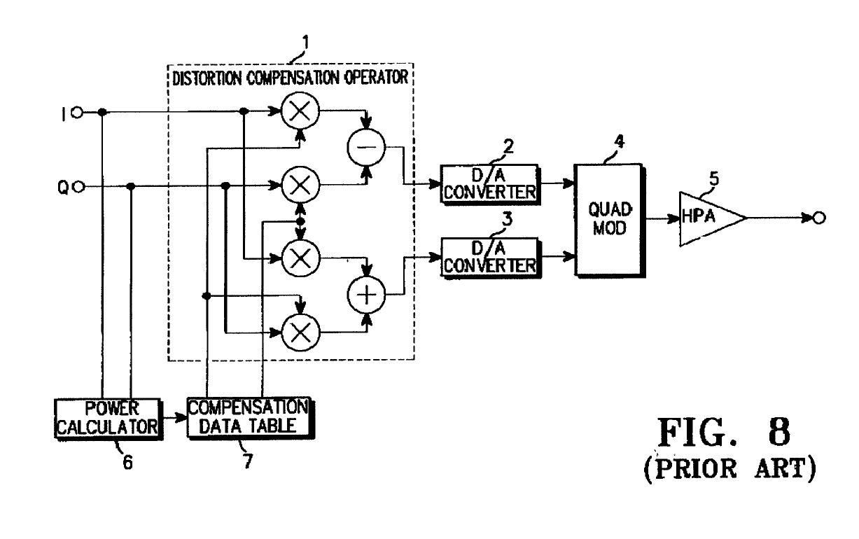

FIG. 9 illustrates a structure of another conventional non-linear distortion compensation circuit; and

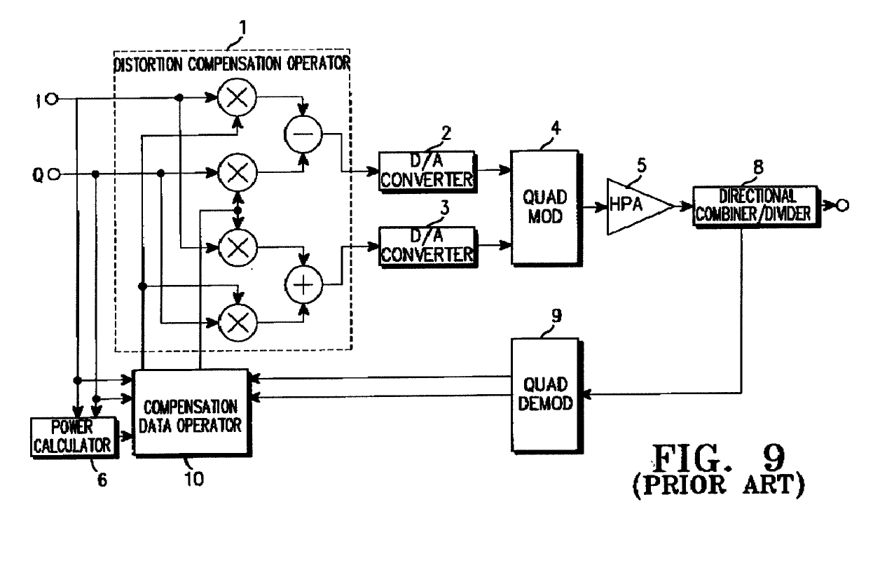

FIG. 10 illustrates a structure of a non-linear distortion compensation circuit according to a second embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

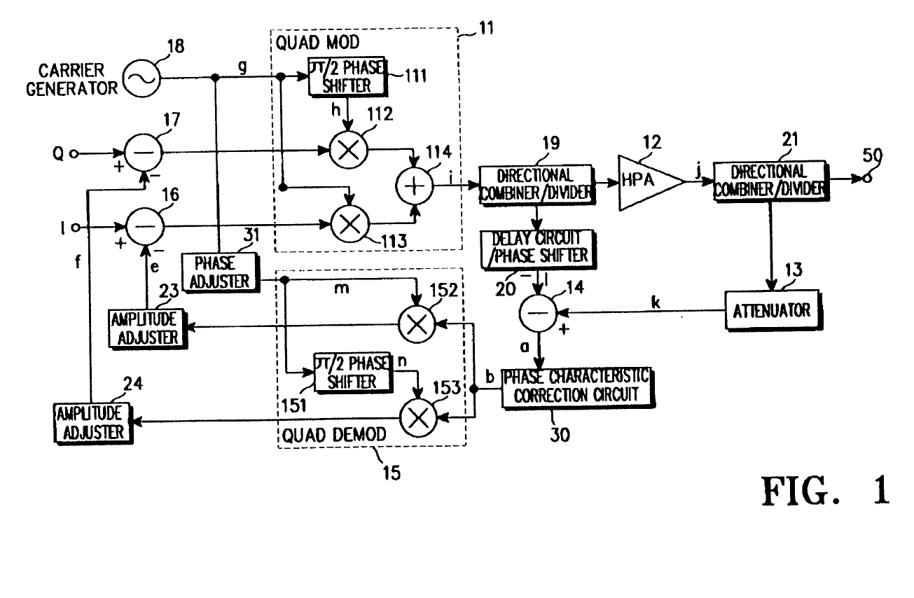

FIG. 1 illustrates a structure of a non-linear distortion compensation apparatus according to a first embodiment of the present invention. The non-linear distortion compensation apparatus according to the present invention is applied to a transmitter device for performing non-linear high-power amplification after quadrature modulation of a baseband signal. By function, the circuit of FIG. 1 is divided into (1) a high-power amplifier (HPA) 12 for performing non-linear high-power amplification, (2) a distortion extractor for extracting a non-linear distortion component from a non-linearly high-power amplified modulated signal provided from the high-power amplifier 12, (3) a phase characteristic corrector for correcting a phase characteristic so that the non-linear distortion component has the same phase delay over its frequency band just before being subjected to quadrature demodulation, (4) a quadrature demodulation section for quadrature-demodulating the distortion component extracted by the distortion extractor into a baseband distortion component, and (5) a distortion overlapping section for overlapping the input baseband signal with an inversed distortion component of the baseband distortion component output from the quadrature demodulation section.

A structure and operation of the non-linear distortion compensation circuit will be described herein below with respect to FIG. 1. The distortion extractor is comprised of directional combiners/dividers 19 and 21, a delay circuit/phase shifter 20, an attenuator 13 and a subtracter 14. The distortion overlapping section is comprised of amplitude adjusters 23 and 24, and subtracters 16 and 17. The phase characteristic corrector corresponds to a phase characteristic correction circuit 30, and the quadrature demodulation section corresponds to a quadrature demodulator 15. Further, the non-linear distortion compensation circuit for the transmitter includes a quadrature modulator 11 for quadrature-modulating a transmission signal and a carrier generator 18 for generating a carrier signal.

As illustrated in FIG. 1, the quadrature modulator 11 is comprised of a π/2 phase shifter 111, multipliers 112 and 113, and an adder 114, while the quadrature demodulator 15 is comprised of a π/2 phase shifter 151 and multipliers 152 and 153.

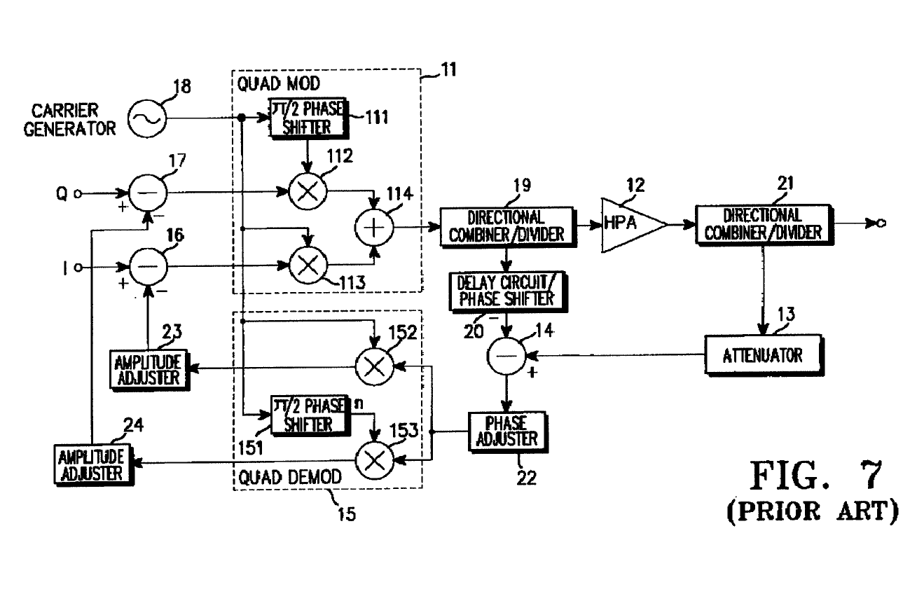

Reference will now be made to the differences between the conventional nonlinear distortion compensation circuit of FIG. 7 and the novel non-linear distortion compensation circuit of FIG. 1. The novel non-linear distortion compensation circuit interposes the phase characteristic correction circuit 30 between the subtracter 14 and the quadrature demodulator 15. Further, the non-linear distortion compensation circuit includes a phase adjuster 31 interposed between the carrier generator 18 and the quadrature demodulator 15. Phase adjuster 22 of FIG. 7 has been removed. The phase adjuster 31 has the same function as the phase adjuster 22. The other structures of FIG. are equal to those of the non-linear distortion compensation circuit of FIG. 7.

Alternatively, the phase adjuster 31 may be arranged in front of the phase characteristic correction circuit 30. That is, although the phase adjuster 31 is interposed between the subtracter 14 and the phase characteristic correction circuit 30, it will have the same effects as it does in its location shown in FIG. 1. When phase adjuster 31 is located between subtractor 14 and phase characteristic correction circuit 30 a carrier signal generated by the carrier generator 18 is provided to the quadrature demodulator in the same manner as shown in FIG. 7. The phase adjuster 31 adjusts a phase of the carrier output from the carrier generator 18 or the extracted non-linear distortion component, and provides the phase-adjusted signal to the quadrature demodulator 15. In this way, the phase adjuster 31 accurately overlaps the phase-inversed distortion component of the baseband distortion component with the baseband signal in the subtracters 16 and 17 included in the distortion overlapping section.

Returning again, to FIG. 1, the subtracters 16 and 17 subtract the distortion components e and f from baseband signals I and Q, respectively, and then provide the subtracted signals to the quadrature modulator 11. The π/2 phase shifter 111 in the quadrature modulator 11 shifts a phase of the carrier signal g, received from the carrier generator 18, by π/2, and provides the phase-shifted carrier signal h to the multiplier 112. The carrier signal g generated by the carrier generator 18 is also provided to the multiplier 113. The multiplier 112 then multiplies the π/2-phase-shifted carrier h from the π/2 phase shifter 111, by the baseband signal Q, and provides its output to the adder 114. At the same time, the multiplier 113 multiplies the carrier g, generated by the carrier generator 18, by the baseband signal I, and provides its output to the adder 114. The adder 114 adds the output signal of the multiplier 112 and the output signal of the multiplier 113, thus outputting a quadrature-modulated signal i. The quadrature-modulated signal i is divided into two signals by the directional combiner/divider 19: one of the divided signals is provided to the high-power amplifier 12, while the other divided signal is provided to the delay circuit/phase shifter 20.

The high-power amplifier 12 non-linearly high-power amplifies the quadrature-modulated signal by a gain of K. An output signal j of the high-power amplifier 12 is divided again into two signals by the directional combiner/divider 21: one of the divided signals is provided as an output signal 50, while the other divided signal is provided to the attenuator 13. The attenuator 13 attenuates the provided signal by a reciprocal (1/K) of the gain of the high-power amplifier 12. An output signal k of the attenuator 13 is provided to the subtracter 14.

Meanwhile, the other divided signal output from the directional combiner/divider 19 is provided to the delay circuit/phase shifter 20. The delay circuit/phase shifter 20 shifts the phase of the divided signal and provides its output signal I to the subtracter 14. The subtracter 14 then subtracts the output signal I of the delay circuit/phase delay 20 from the output signal k of the attenuator 13. That is, the subtracter 14 subtracts the distortion-free quadrature-modulated signal 1, output through the directional combiner/divider 19 and the delay circuit/phase shifter 20, from the distortion component-included signal k output through the high-power amplifier 12, the directional combiner/divider 21 and the attenuator 13. By doing so, the subtracter 14 extracts only the non-linearly amplified distortion component a.

The non-linearly amplified distortion component a output from the subtracter is provided to the phase characteristic correction circuit 30. The phase characteristic correction circuit 30 corrects the phase characteristic such that the non-linear distortion component a has the same phase delay over its entire frequency band just before being subjected to quadrature demodulation. The phase characteristic correction circuit 30 provides its output b to the multipliers 152 and 153 in the quadrature demodulator 15.

The quadrature demodulator 15 receives the carrier signal g generated by the carrier generator 18 after phase adjustment by the phase adjuster 31. The multiplier 152 in the quadrature demodulator 15 multiplies the phase characteristic-corrected nonlinear distortion component b, received from the phase characteristic correction circuit 30, by a phase-adjusted carrier m received from the phase adjuster 31, for quadrature demodulation, and then provides its output to the amplitude adjuster 23. Further, the π/2 phase shifter 151 shifts the phase of the phase-adjusted carrier m, output from the phase adjuster 31 by π/2, and provides the phase-shifted carrier n to the multiplier 153. The multiplier 153 multiplies the phase-shifted carrier n by the phase characteristic-corrected non-linear distortion component b, received from the phase characteristic correction circuit 30, for quadrature demodulation, and provides its output to the amplitude adjuster 24. The baseband distortion components e and f output from the amplitude adjusters 23 and 24, respectively, are applied to the subtracters 16 and 17 receiving the baseband signals I and Q, respectively.

As a result, the subtracter 16 provides the baseband signal I overlapped with an inverse distortion component to the quadrature modulator 11 by previously subtracting the distortion component e caused by the amplification operation of the high-power amplifier 12 from the baseband signal I. Also, the subtracter 17 provides the quadrature modulator 11 with the baseband signal Q overlapped with the inverse distortion component by previously subtracting distortion component f caused by the amplification operation of the high-power amplifier 12 from the baseband signal Q. That is, the subtracters 16 and 17 overlap the input baseband signals with the distortion components having an inverse baseband distortion characteristic caused by quadrature demodulation of the distortion components extracted by the subtracter 14, i.e., a characteristic of removing the non-linear distortion components generated during high-power amplification. Thus, it is possible to remove the non-linear distortion components generated by the high-power amplifier 12 during high-power amplification after quadrature-modulation of the inverse distortion component-overlapped baseband signals by the quadrature modulator 11.

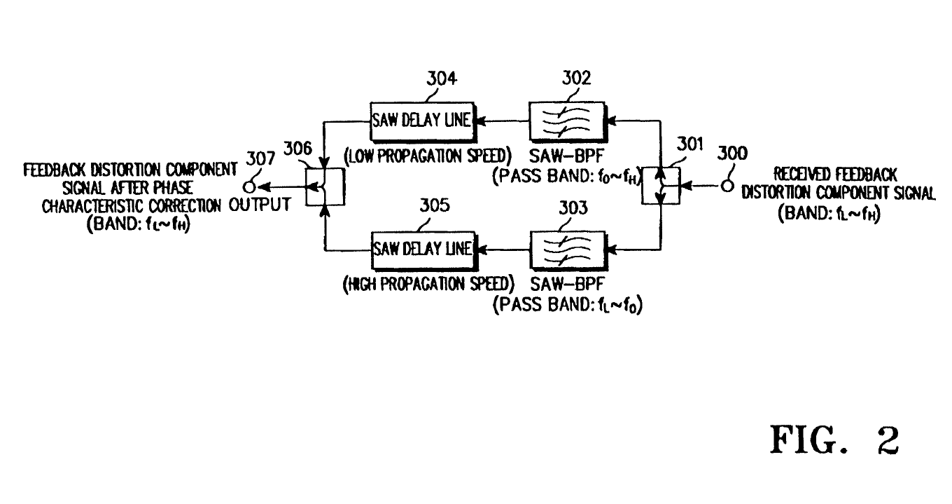

FIG. 2 illustrates a detailed structure of the phase characteristic correction circuit 30. Referring to FIG. 2, the phase characteristic correction circuit 30 is comprised of (i) a divider 301, for dividing a frequency band of the distortion component extracted by the subtracter 14 into a plurality of frequency bands, (ii) filter circuits 302 and 303 for bandpass filtering the associated frequency band-divided signals, (iii) delay circuits 304 and 305 for performing phase adjustment such that the output signals of the filter circuits have the same phase delay, and (iv) a signal combiner 306 for combining the output signals of the delay circuits.

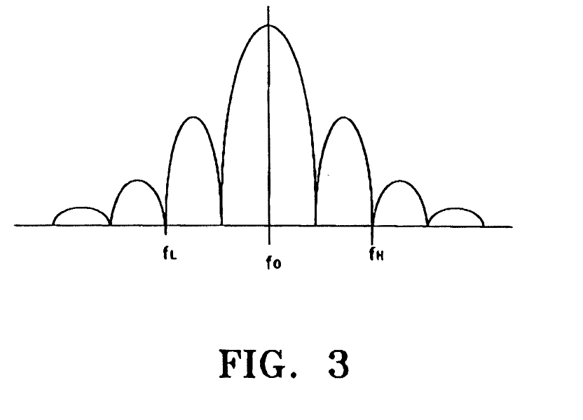

In the following description, it will be assumed that the divider 301 divides the frequency band of the distortion component into two sub frequency bands. The divided signals are applied to bandpass filters 302 and 303 having their own unique pass bands, respectively. The bandpass filters 302 and 303 each can be implemented with a SAW (Surface Acoustic Wave) filter. Therefore, as illustrated in FIG. 3, when the main lobe of the quadrature-modulated waves has a center frequency f⁰[Hz], the bandpass filter 302 has a pass band of f^{0˜}f^{H}[Hz] (i.e., f^{O} through f^{H}) and the bandpass filter 303 has a pass band of f^{L˜}f⁰[Hz]. Each of delay lines 304 and 305 for delaying output signals of the associated bandpass filters 302 and 303 is comprised of a SAW delay line. The delay lines 304 and 305 are structured to have different signal propagation speeds according to the frequency of the input signal, such that the signal propagation speed is relatively high at lower frequencies and relatively low at higher frequencies. That is, the signal propagation speed is low in the delay circuit 304 connected to the output of the bandpass filter 302 for passing the high frequencies, and the signal propagation speed is high in the delay circuit 305 connected to the output of the bandpass filter 303 for passing the low frequencies.

In operation, the distortion component with a frequency band f^{L˜}f^{H}[Hz], received from the subtracter 14 through an input node 300, is divided into two distortion components by the divider 301. The distortion component with a frequency band f^{0˜}f^{H}[Hz] passes through the bandpass filter 302, and is delayed by the delay line circuit 304 so as to reduce the phase delay. Further, the distortion component with a frequency band f^{L}˜f⁰[Hz] passes through the bandpass filter 303, and is delayed by the delay line circuit 305 so as to increase the phase delay. The outputs of the delay line circuits 304 and 305 are provided to the combiner circuit 306. The combiner circuit 306 combines the output signals of the delay line circuits 304 and 305. As a result, the distortion components, though having different frequencies, may have the same phase delay, and are provided to the multiplier 152 and 153 in the quadrature demodulator 15 through an output node 307.

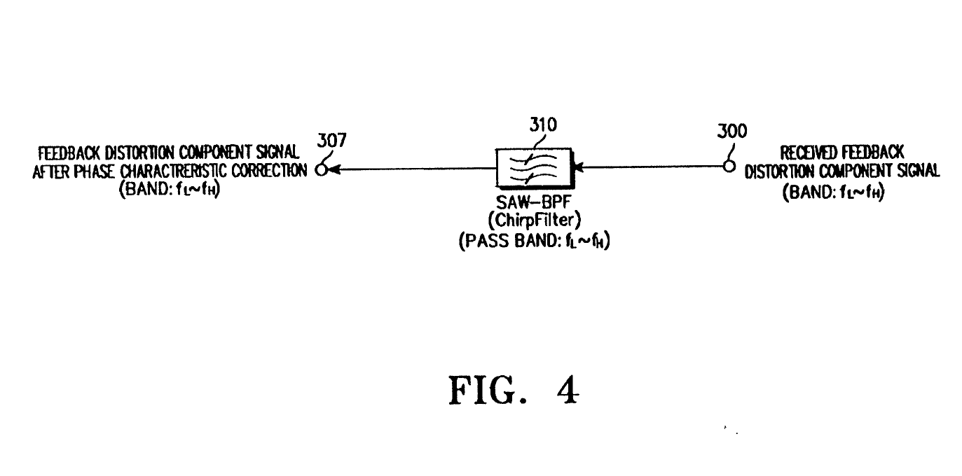

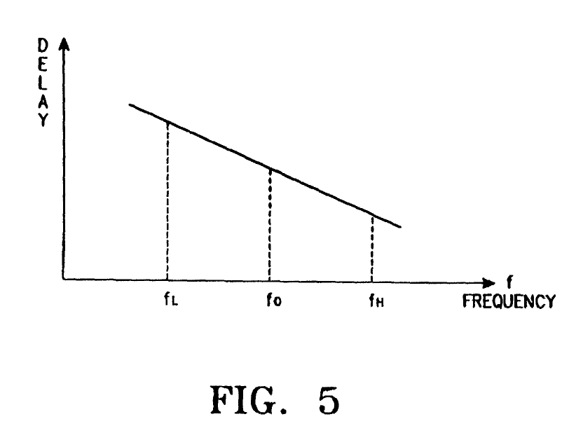

FIG. 4 illustrates a modified structure of the phase characteristic correction circuit 30. Referring to FIG. 4, the phase characteristic correction circuit 30 is comprised of a bandpass filter 310, a pass band of which is equal to a frequency band of the distortion component extracted by the distortion extractor. The bandpass filter 310 has a decreased group delay as the frequency increases. For example, the bandpass filter 310 can be comprised of a chirp filter combined with a SAW filter, a pass band of which is equal to the frequency band f^{L}˜f^{H}[Hz] of the distortion component included in the output of the high-power amplifier 12, fed back to the quadrature modulator 11. The group delay characteristic of the bandpass filter 310 is shown in FIG. 5. As illustrated in FIG. 5, the bandpass filter 310 is constructed such that the delay decreases as the frequency increases.

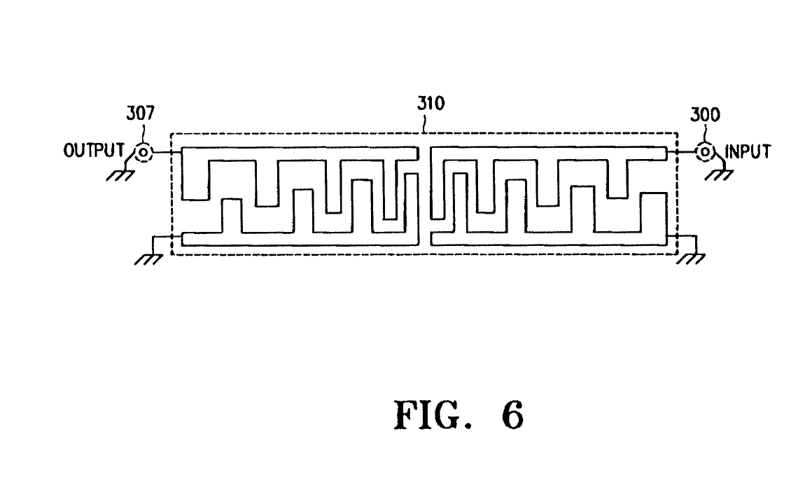

FIG. 6 illustrates a copper film pattern formed on a substrate, for the SAW-chirp filter 310. The SAW-chirp filter is comprised of a pair of IDT (interdigital transducer) electrodes, like a standard SAW filter. As illustrated in FIG. 6, the electrode pattern is formed on the substrate such that a gap between and a width of IDT electrode branches become increasingly narrowed. The distortion component extracted by the distortion extractor is applied to the bandpass filter 310 through the input node 300. The feedback distortion components at the output node 307, after being passed through the bandpass filter 310, have the same phase delay, though they have different frequencies. Here, the “feedback distortion component” refers to the distortion component included in the output of the high-power amplifier 12, which is to be fed back to the quadrature modulator 11.

In this manner, the non-linear distortion compensation circuit according to the present invention can compensate for distortion of a wideband modulation signal output from the non-linear high-power amplifier.

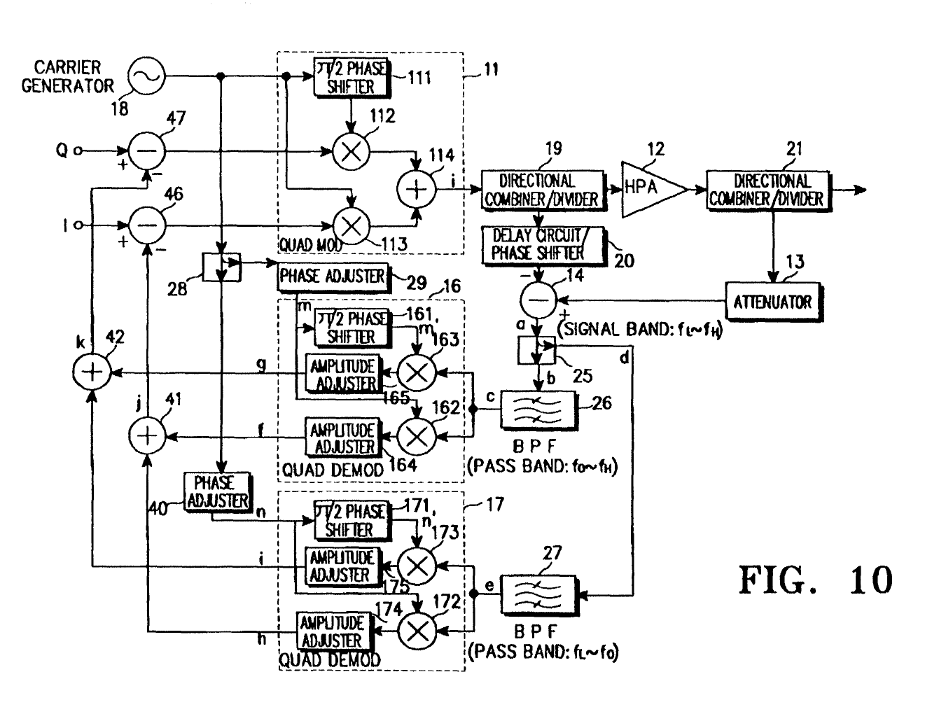

FIG. 10 illustrates a non-linear distortion compensation circuit according to a second embodiment of the present invention. The non-linear distortion compensation circuit according to the present invention is applied to a transmitter for performing non-linear high-power amplification after quadrature modulation of a baseband signal.

By function, the circuit of FIG. 10 is divided into (1) a high-power amplifier (HPA) 12 for performing non-linear high-power amplification, (2) a distortion extractor for extracting a non-linear distortion component from a non-linearly high-power amplified modulated signal provided from the high-power amplifier 12, (3) a frequency divider for dividing a frequency band of the extracted non-linear distortion component into a plurality of sub frequency bands, (4) a plurality of quadrature demodulation sections for independently quadrature-demodulating the non-linear distortion components in the associated divided frequency bands into baseband distortion components after phase adjustment, (5) a combiner for combining the non-linear distortion components corresponding to the divided frequency bands after quadrature demodulation, and (6) a distortion overlapping section for overlapping the input baseband signal with an inversed distortion component of the combined baseband distortion component.

A structure of the non-linear distortion compensation circuit will be described in detail herein below with respect to FIG. 10. The distortion extractor is comprised of directional combiners/dividers 19 and 21, a delay circuit/phase shifter 20, an attenuator and a subtracter 14. The frequency divider is comprised of a divider circuit 25 for dividing the distortion component output from the distortion extractor into a predetermined number of signals required to detect the respective frequency bands, and bandpass filters (BPFs) having different pass bands, the number of the bandpass filters being identical to the number of frequency bands. In the following description, it will be assumed that the frequency divider includes two different bandpass filters 26 and 27. Therefore, the divider circuit 25 divides the received distortion component into two distortion components. As illustrated in conjunction with FIG. 3, when the main lobe of the quadrature-modulated waves has a center frequency f⁰[Hz] and the distortion component has a frequency band f^{L˜}f^{H}[Hz], the bandpass filter 26 has a pass band of f^{0˜}f^{H}[Hz] and the bandpass filter 27 has a pass band of f^{L˜}f⁰[Hz]. The bandpass filters 26 and 27 both have a narrow band, thus requiring a precipitous attenuation characteristic. Therefore, it is preferable to use a SAW filter for the bandpass filters 26 and 27.

Further, in the embodiment of the present invention, and by way of this example, the quadrature demodulation sections include two quadrature demodulators 16 and 17. The number of quadrature demodulators would change relative to the frequency bands. The quadrature demodulator 16 is comprised of a π/2 phase shifter 161, multipliers 162 and 163, and amplitude adjusters 164 and 165. Similarly, the quadrature demodulator 17 is comprised of a π/2 phase shifter 171, multipliers 172 and 173, and amplitude adjusters 174 and 175. In addition, the combiner for combining the outputs of the quadrature demodulators 16 and 17 is comprised of two adders 41 and 42. The distortion overlapping section is comprised of two subtracters 46 and 47. Further, the non-linear distortion compensation circuit includes a quadrature modulator 11 and a carrier generator 18. The quadrature modulator 11 is comprised of a π/2 phase shifter 111, multipliers 112 and 113, and an adder 114. A divider circuit 28 divides a carrier signal output from the carrier generator 18 into two signals, and provides the divided carrier signals to the quadrature demodulators 16 and 17. Phase adjusters 29 and 40 independently perform phase adjustment on the carrier signals provided to the quadrature demodulators 16 and 17, respectively. Specifically, the phase adjusters 29 and 40 provide the carrier signal output from the carrier generator 18 to the quadrature demodulators 16 and 17 after phase adjustment, so that inverse distortion components of the baseband distortion components can be accurately overlapped with the input baseband signals at the subtracters 46 and 47.

The subtracters 46 and 47 subtract the distortion components j and k from baseband signals I and Q, respectively, and then provide the subtracted signals to the quadrature modulator 11. The π/2 phase shifter 111 in the quadrature modulator 11 shifts the phase of a carrier signal received from the carrier generator 18 by π/2, and provides the phase-shifted carrier signal to the multiplier 112. The carrier signal generated by the carrier generator 18 is also provided to the multiplier 113. The multiplier 112 then multiplies the π/2-phase-shifted carrier signal by the signal determined by subtracting the distortion component k from the baseband signal Q, and provides its output to the adder 114. At the same time, the multiplier 113 multiplies the carrier signal, generated by the carrier generator 18, by the value determined by subtracting the distortion component j from the baseband signal I, and provides its output to the adder 114. The adder 114 adds the output signal of the multiplier 112 and the output signal of the multiplier 113, thus outputting a quadrature-modulated signal i.

The quadrature-modulated signal i output from the quadrature modulator 11 is divided into two signals by the directional combiner/divider 19: one of the divided signals is provided to the high-power amplifier 12, while the other divided signal is provided to the delay circuit/phase shifter 20. The high-power amplifier 12 non-linearly high-power amplifies the divided quadrature-modulated signal by a gain of K. An output signal of the non-linear high-power amplifier 12 is divided again into two signals by the directional combiner/divider 21: one of the divided signals is provided as an output signal, while the other divided signal is provided to the attenuator 13. The attenuator 13 attenuates the provided signal by a reciprocal (1/K) of the gain of the high-power amplifier 12, and provides the attenuated signal to the subtracter 14. The delay circuit/phase shifter 20 shifts a phase of the other divided signal received from the directional combiner/divider 19, and provides its output signal to the subtracter 14.

The subtracter 14 then subtracts the output signal of the delay circuit/phase delay 20 from the output signal of the attenuator 13. That is, the subtracter 14 subtracts the distortion-free quadrature-modulated signal, output through the directional combiner/divider 19 and the delay circuit/phase shifter 20, from the distortion component-included signal output through the high-power amplifier 12, the directional combiner/divider 21 and the attenuator 13. By doing so, the subtracter 14 extracts only the non-linearly amplified distortion component a.

The non-linearly amplified distortion component a has a frequency band f^{L}˜f^{H}[Hz]. The non-linearly amplified distortion component a is divided into signals b and d by the divider circuit 25. The divided signal b is applied to the bandpass filter 26, while the divided signal d is applied to the bandpass filter 27. The bandpass filter 26 passes only a distortion component c with a frequency band f⁰˜f^{H}[Hz] out of the input divided signal b. The distortion component c is provided to the multipliers 162 and 163 in the quadrature demodulator 16. Likewise, the bandpass filter 27 passes only a distortion component e with a frequency band f^{L}˜f⁰[Hz] out of the input divided signal d. The distortion component e is provided to the multipliers 172 and 173 in the quadrature demodulator 17. Here, since the distortion components c and e have different frequencies, they have different phase delay compared with the distortion component a.

Meanwhile, the divider circuit 28 divides the carrier signal output from the carrier generator 18 into two signals, and provides one of the divided carrier signals to the phase adjuster 29 and the other divided carrier signal to the phase adjuster 40. The phase adjusters 29 and 40 perform phase adjustment such that the carrier signals have the same phase delay as the distortion components output from the quadrature demodulators 16 and 17. Since the distortion components applied to the quadrature demodulators 16 and 17 have different frequencies, they have different phase delays. Therefore, the phase adjusters 29 and 40 are constructed to have different phase delays so as to match a phase of the carrier signals to a phase of the distortion components provided to the quadrature demodulators 16 and 17.

The multiplier 162 in the quadrature demodulator 16 multiplies the non-linear distortion component c by the carrier signal m received from the phase adjuster 29, and provides its output to the amplitude adjuster 164. The multiplier 163 multiplies the non-linear distortion component c by a carrier signal m′ determined by shifting a phase of the phase-adjusted carrier signal m output from the phase adjuster 29 by π/2 by the π/2 phase shifter 161, and provides its output to the amplitude adjuster 165. The amplitude adjusters 164 and 165 adjust amplitude of the input signals. The amplitude-adjusted baseband distortion components f and g output from the amplitude adjusters 164 and 165 are provided to the adders 41 and 42, respectively.

Similarly, the multiplier 172 in the quadrature demodulator 17 multiplies the non-linear distortion component e by the carrier signal n received from the phase adjuster 40, and provides its output to the amplitude adjuster 174. The multiplier 173 multiplies the non-linear distortion component e by a carrier signal n′ determined by shifting a phase of the phase-adjusted carrier signal n output from the phase adjuster 40 by π/2 by the π/2 phase shifter 171, and provides its output to the amplitude adjuster 175. The amplitude adjusters 174 and 175 adjust amplitude of the input signals. The amplitude-adjusted baseband distortion components h and i output from the amplitude adjusters 174 and 175 are provided to the adders 41 and 42, respectively.

The output signal f of the amplitude adjuster 164 in the in the quadrature demodulator 16 and the output signal h of the amplitude adjuster 174 in the quadrature demodulator 17 are provided to the adder 41. Further, the output signal g of the amplitude adjuster 165 in the in the quadrature demodulator 16 and the output signal i of the amplitude adjuster 175 in the quadrature demodulator 17 are provided to the adder 42. As the phase adjusters 29 and 40 properly adjust a phase of the carrier signals output from the carrier generator 18, the distortion components f, g, h and i have the same phase delay after quadrature demodulation of the phase-adjusted carrier signals.

The adder 41 adds the distortion component f and the distortion component h and provides a resulting distortion component j to the subtracter 46. The adder 42 adds the distortion component g and the distortion component i and provides a resulting distortion component k to the subtracter 47. The subtracter 46 subtracts the distortion component j, generated during an amplification operation of the high-power amplifier 12, from the baseband signal I, thus providing a reverse distortion component-overlapped baseband signal I to the quadrature modulator 11. Likewise, the subtracter 47 subtracts the distortion component k, generated during an amplification operation of the high-power amplifier 12, from the baseband signal Q, thus providing a reverse distortion component-overlapped baseband signal Q to the quadrature modulator 11.

That is, the subtracters 46 and 47 overlap the baseband signals I and Q with the baseband distortion components j and k having a reverse distortion characteristic (removing the non-linear distortion components generated during high-power amplification), caused by quadrature-demodulating the distortion component extracted by the subtracter 14. Therefore, after the inverse distortion component-overlapped baseband signals are quadrature modulated by the quadrature modulator 11, the nonlinear distortion generated during non-linear high-power amplification by the highpower amplifier 12 is removed.

In sum, the non-linear distortion compensation circuit according to the second embodiment of the present invention extracts a non-linear distortion component generated during high-power amplification, and feeds back the distortion component so as to subtract the quadrature-modulated distortion components from the input baseband signals I and Q. As a result, the non-linear distortion generated by the high-power amplifier is compensated.

Summarizing, the non-linear distortion compensation circuit includes a plurality of feedback loops for the distortion components, and the feedback loops independently phase-adjust the distortion components so that the distortion components have the same phase delay after quadrature demodulation. As a result, the non-linear distortion compensation circuit can perform effective non-linear distortion compensation over the entire frequency band of even a wideband modulation signal.

Although the non-linear distortion compensation circuit of FIG. 10 has two feedback loops for removing the non-linear distortion components generated during the high-power amplification, it is also possible to use three or more feedback loops to thus remove the distortion components, by finely dividing the frequency band of the distortion component generated by the high-power amplification. Further, the SAW filter used for the bandpass filter may be replaced with another filter having a precipitous attenuation characteristic.

As described above, it is possible to prevent non-linear distortion by feeding back the distortion component generated by the high-power amplifier. In addition, it is possible to reduce a correction error generated according to the frequency component, by adjusting a phase of the feedback signal according to the frequency. That is, it is possible to effectively prevent a distortion characteristic of a wideband signal, generated during high-power amplification.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for compensating for non-linear distortion generated during non-linear high-power amplification in a transmitter after quadrature modulation of a baseband signal, comprising the steps of:
extracting a non-linear distortion component from a non-linearly high-power amplified modulated signal;
correcting a phase characteristic such that respective frequency signals in a frequency band of the non-linear distortion component have equal phase delays;
quadrature-demodulating the corrected distortion component into a baseband distortion component; and
overlapping a phase-inverted distortion component of the quadrature-demodulated baseband distortion component with the baseband signal.

2. An apparatus for compensating for non-linear distortion generated during non-linear high-power amplification in a transmitter after quadrature modulation of a baseband signal, comprising:
a distortion extractor for extracting a non-linear distortion component from a non-linearly amplified quadrature-modulated signal;
a phase characteristic corrector for correcting a phase characteristic such that respective frequency signals in a frequency band of the non-linear distortion component have equal phase delay;
a quadrature demodulator for quadrature-demodulating the phase characteristic-corrected distortion component into a baseband distortion component; and
a distortion overlapping section for overlapping a phase-inverted distortion component of the baseband distortion component output from the quadrature demodulator with the baseband signal.

3. The apparatus as claimed in claim 2, wherein the phase characteristic corrector comprises:
a frequency band divider for dividing a frequency band of the distortion component extracted by the distortion extractor into a plurality of frequency bands;
a plurality of delay circuits for performing phase adjustment such that the respective frequency bands of the distortion component divided by the frequency band divider have equal phase delays; and
a signal combiner for combining outputs of the plurality of delay circuits.

4. The apparatus as claimed in claim 2, wherein the phase characteristic corrector comprises a filter, a pass band of which is equal to the frequency band of the distortion component extracted by the distortion extractor, wherein the filter group delay decreases as the frequency increases.

5. A method for compensating for non-linear distortion generated during non-linear high-power amplification in a transmitter after quadrature modulation of a baseband signal, comprising the steps of:
extracting a non-linear distortion component from a non-linearly high-power amplified quadrature-modulated signal;
dividing a frequency band of the extracted non-linear distortion component into a plurality of frequency bands;
quadrature-demodulating the frequency band-divided non-linear distortion components into baseband distortion components such that the quadrature-demodulated baseband distortion components have equal phase delays;
combining the quadrature-demodulated baseband non-linear distortion components; and
overlapping phase-inverted distortion component of the combined baseband distortion component with the baseband signal.

6. An apparatus for compensating for non-linear distortion generated during non-linear high-power amplification in a transmitter after quadrature modulation of a baseband signal, comprising:
a distortion extractor for extracting a nonlinear distortion component from a non-linearly high-power amplified quadrature-modulated signal;
a frequency divider for dividing a frequency band of the extracted non-linear distortion component into a plurality of frequency bands;
a plurality of quadrature demodulators for quadrature demodulating the frequency band-divided non-linear distortion components into baseband distortion components such that respective frequencies have equal phase delays;
a combiner for combining the quadrature-demodulated baseband non-linear distortion components; and
a distortion overlapping section for overlapping phase-inverted distortion component of the combined baseband distortion component with the baseband signal.

7. The apparatus as claimed in claim 6, further comprising at lease one phase adjuster for independently adjusting a phase of a carrier signal input into the plurality of quadrature demodulators.
